(19) United States
(12) Patent Application Publication
(10) Pub. No.: US 2024/0348161 A1
(43) Pub. Date: Oct. 17, 2024

(54) HIGH VOLTAGE BATTERY CONTROL SYSTEM AND HIGH SIDE VOLTAGE BOOST CONTROL CIRCUIT THEREOF

(71) Applicant: TRITIUM ELECTRONICS PTE. LTD., Singapore (SG)

(72) Inventors: Tai-You Lu, Hsinchu (TW); Pao-Cheng Chiu, Hsinchu (TW); Zhi-Xin Chen, Hsinchu (TW); Tse-Ju Liao, Hsinchu (TW)

(21) Appl. No.: 18/629,985

(22) Filed: Apr. 9, 2024

Related U.S. Application Data
(60) Provisional application No. 63/496,011, filed on Apr. 13, 2023.

(51) Int. Cl. H02M 3/07; H02J 7/04; H02M 3/158

(52) U.S. Cl. CPC H02M 3/07; H02J 7/04; H02M 3/158

(57) ABSTRACT

A high side voltage boost control circuit of a high voltage battery control system comprises: a linear regulator circuit powered by a first high voltage power rail to generate a high side reference ground potential; a boost circuit powered by a first low voltage power rail, converting it into a second high voltage power rail according to a boost enable signal and regulating a boosted voltage to a predetermined target voltage; a feedback signal generation circuit powered by the first low voltage power rail to generate a feedback voltage according to the boosted voltage; and a comparison circuit comparing the feedback voltage with a reference voltage to generate the boost enable signal. The battery voltage is higher than a withstand voltage of at least one device in the boost, feedback, and comparison circuits.

### CROSS REFERENCE

The present invention claims priority to U.S. 63/496,011 filed on Apr. 13, 2023.

### BACKGROUND OF THE INVENTION

### Field of Invention

The present invention relates to a high voltage battery control system and a high side voltage boost control circuit thereof; particularly, it relates to such high voltage battery control system and high side voltage boost control circuit thereof wherein at least part of circuits thereof can operate in a first low voltage power rail formed by a high side reference ground potential and a battery voltage. This allows the high voltage battery control system and the high side voltage boost control circuit thereof to use electronic devices with a relatively lower withstand voltage.

### Description of Related Art

FIG. 1 illustrates a voltage boost control circuit 10 of a prior art high voltage battery control system 1, wherein the voltage boost control circuit 10 is coupled to a battery voltage pin BAT and a boost voltage pin CPO of the high voltage battery control system 1. The voltage boost control circuit 10 is configured to provide a boosted voltage VCPO at the boost voltage pin CPO, enabling the high voltage battery control system 1 to turn ON or OFF a metal oxide semiconductor field effect transistor (MOSFET) of the high voltage battery control system 1, thereby controlling a charging/discharging current to decide whether to perform charging/discharging operations on a high voltage battery. The high voltage battery has a battery voltage side, which is a high side. The voltage boost control circuit 10 includes a linear regulator 11, a boost circuit 12, an amplitude level converter 13, and a boost capacitor CP.

A battery high voltage power rail formed by a high voltage battery voltage VBAT and a ground potential GND, supplies power to the linear regulator 11, meaning that the linear regulator 11 is powered by the battery high voltage power rail, where, for example, the battery voltage VBAT (relative to the ground potential GND) and a voltage drop of the battery high voltage power rail could be 60V. The linear regulator 11 linearly converts the battery voltage VBAT into a voltage V1, wherein the voltage V1 is a low voltage, for example, 5V (relative to the ground potential GND), to be input into the boost circuit 12. The boost circuit 12 is powered by a ground low voltage power rail formed by a low voltage VDD and the ground potential GND. The boost circuit 12 boosts the voltage V1 (for example, 5V) to a voltage V2 (for example, 12V), to be input into the amplitude level converter 13. The ground low voltage power rail is, for example, formed by a 5V voltage and the ground potential GND. The amplitude level converter 13 is powered by a level conversion high voltage power rail formed by the voltage V2 and the ground potential GND. The amplitude level converter 13 receives the voltage V2 and a clock signal CLK1 to convert the amplitude of the clock signal CLK1 (for example, 5V) into a clock signal CLK2 with an amplitude of voltage V2 (for example, 12V) for charging/discharging a boost capacitor CP. Therefore, the voltage waveform at node VX will be a square wave oscillating signal, switching between the battery voltage VBAT and the battery voltage VBAT plus the voltage V2 (for example, 12V). The boosted voltage VCPO at the boost voltage pin CPO is then increased from the battery voltage VBAT to a level sufficient to operate the MOSFET of the high-voltage battery control system 1 through a diode D1 to the right, charging an external capacitor CL, supplying the switch control system of the high-voltage battery control system 1, to decide the turn ON/OFF of the MOSFET of the high voltage battery control system 1.

The term “low voltage” primarily refers to voltages in digital or analog circuits not used for direct power operations. The low voltage typically denotes a minimum voltage range that supports the normal operation of digital or analog circuits, and the minimum voltage range is relatively lower because the design of digital or analog circuits aims to minimize power consumption while maintaining high-speed operation. For example, in modern digital circuits, low voltage operation ranges can vary from several hundred millivolts (mV) to several volts (V). Some applications might use 5V, 3V, 1.8V, 1.2V, or even lower operating voltages.

Conversely, the term “high voltage” mainly pertains to operating voltages in power circuits, indicating voltage ranges the power circuits are designed to handle or control. These power circuits are often used in applications like electric power conversion and driving large current loads, hence their operating voltages are relatively higher. For example, some power applications might use 12V, 15V, 60V, 120V, 33 kV, and in some cases, such as battery management systems for electric vehicles or large power supplies, this range might be even higher.

As semiconductor technology advances, the definitions of low and high voltages are constantly evolving. For instance, as process technology progresses, the operating voltage of digital circuits continues to decrease, while power circuits are expanding their voltage handling range to increase efficiency and reliability.

The disadvantages of the prior art boost control circuit 10 include at least the following two points:

1. The voltage boost control circuit 10 is an open-loop circuit that does not sense the boosted voltage VCPO, thus the boost control circuit 10 continues to operate continuously, causing excessive power loss. If there is no need to maintain the high boosted voltage VCPO, for example, if it is required to reduce the boosted voltage VCPO from 12V to 5V, an additional circuit is needed to control the level of the boosted voltage VCPO.
2. Since the amplitude of the clock signal CLK2 (for example, 12V) is high, the amplitude level converter 13 needs to use devices with high withstand voltages (for example, 12V). Moreover, the boost capacitor CP needs to be a device with an even higher withstand voltage (for example, 60V). Therefore, the circuit of this prior art has higher costs and larger sizes.

In view of the above, the present invention proposes a high voltage battery control system and a high side voltage boost control circuit thereof that can be implemented using low voltage devices, achieving the effects of saving integrated circuit chip area and reducing power loss. Additionally, the high voltage battery control system and a high side voltage boost control circuit thereof of the present invention, by sensing the boosted voltage VCPO and adjusting circuit operations adaptively through feedback control, aim to expand the application range and save electricity.

### SUMMARY OF THE INVENTION

In one perspective, the present invention provides a high side voltage boost control circuit of a high voltage battery control system, comprising: a linear regulator circuit, which is powered by a first high voltage power rail formed by a battery voltage and a ground potential, and is configured to operably generate a high side reference ground potential; a boost circuit, which is powered by a first low voltage power rail formed by the battery voltage and the high side reference ground potential, and is configured to operably convert the first low voltage power rail into a second high voltage power rail formed by a boosted voltage and the high side reference ground potential, and regulate the boosted voltage to a predetermined target voltage according to a boost enable signal; a feedback signal generation circuit, which is powered by the first low voltage power rail, and is configured to operably generate a feedback voltage according to the boosted voltage; anda comparison circuit, which is powered by the first low voltage power rail, and is configured to operably compare the feedback voltage with a reference voltage to generate the boost enable signal; wherein the battery voltage is higher than a withstand voltage of at least one device of the boost circuit, the feedback signal generation circuit, and the comparison circuit; wherein a voltage drop of the first high voltage power rail is higher than a voltage drop of the first low voltage power rail; wherein a voltage drop of the second high voltage power rail is higher than the voltage drop of the first low voltage power rail; wherein the boosted voltage is higher than the battery voltage.

In another perspective, the present invention provides a high voltage battery control system, comprising: a high side voltage boost control circuit, which includes: a linear regulator circuit, which is powered by a first high voltage power rail formed by a battery voltage and a ground potential, and is configured to operably generate a high side reference ground potential; a boost circuit, which is powered by a first low voltage power rail formed by the battery voltage and the high side reference ground potential, and is configured to operably convert the first low voltage power rail into a second high voltage power rail formed by a boosted voltage and the high side reference ground potential, and regulate the boosted voltage to a predetermined target voltage according to a boost enable signal; a feedback signal generation circuit, which is powered by the first low voltage power rail, and is configured to operably generate a feedback voltage according to the boosted voltage; and a comparison circuit, which is powered by the first low voltage power rail, and is configured to operably compare the feedback voltage with a reference voltage to generate the boost enable signal; wherein the battery voltage is higher than a withstand voltage of at least one device of the boost circuit, the feedback signal generation circuit, and the comparison circuit; wherein a voltage drop of the first high voltage power rail is higher than a voltage drop of the first low voltage power rail; wherein a voltage drop of the second high voltage power rail is higher than the voltage drop of the first low voltage power rail; wherein the boosted voltage is higher than the battery voltage; a metal oxide semiconductor field effect transistor (MOSFET) unit, including a charging MOSFET and a discharging MOSFET connected in series between the battery voltage and a battery pack voltage; and a switch control circuit, powered by the second high voltage power rail, configured to control the charging and discharging MOSFETs according to a switch control signal, thereby controlling a charging/discharging current to decide charging/discharging of a high voltage battery.

In one embodiment, the boost circuit includes a voltage multiplier circuit, and when the boost circuit is enabled and is in an open-loop state, converts the first low voltage power rail into an N-times voltage power rail by an N-fold conversion, wherein a voltage drop of the N-times voltage power rail is N times a voltage drop of the first low voltage power rail, and N is a real number greater than 1.

In one embodiment, the feedback signal generation circuit includes a level shifter circuit, which shifts a level of the boosted voltage by a first predetermined level to generate the feedback voltage.

In one embodiment, the feedback signal generation circuit includes a voltage divider circuit, which obtains a divided voltage of the boosted voltage to generate the feedback voltage.

In one embodiment, the predetermined target voltage includes an upper predetermined target voltage and a lower predetermined target voltage, and wherein the comparison circuit includes a hysteresis comparison circuit with a hysteresis function, which compares the feedback voltage with an upper reference voltage and a lower reference voltage, and when the feedback voltage exceeds the upper reference voltage or falls below the lower reference voltage, the hysteresis comparison circuit, through a hysteresis control mechanism, dynamically adjusts a state of the boost enable signal, thereby enabling or disabling the boost circuit to regulate the boosted voltage between the upper predetermined target voltage and the lower predetermined target voltage, where the upper predetermined target voltage and the lower predetermined target voltage correspond to one and the other of the upper reference voltage and the lower reference voltage, respectively.

In one embodiment, the hysteresis comparison circuit includes: an upper limit comparator, which compares the feedback voltage with the upper reference voltage to generate an upper comparison result; a lower limit comparator, which compares the feedback voltage with the lower reference voltage to generate a lower comparison result; and a logic circuit, which dynamically adjusts the state of the boost enable signal through a hysteresis control mechanism according to the upper comparison result and the lower comparison result.

In one embodiment, the hysteresis comparison circuit further includes: an upper limit bias circuit, which provides the upper reference voltage to the upper limit comparator within the first low voltage power rail; and a lower limit bias circuit, which provides the lower reference voltage to the lower limit comparator within the first low voltage power rail.

In one embodiment, the linear regulator circuit includes: a high side differential voltage input stage circuit, which is powered by the first high voltage power rail, and is configured to generate a differential current pair according to a difference between a predetermined reference voltage and the high side reference ground potential; a low side gain stage circuit, which is powered by a second low voltage power rail, has a transresistance, and is configured to convert the differential current pair to generate a transresistance output voltage; and an output amplification stage circuit, which is powered by the first high voltage power rail, and is configured to operably amplify the transresistance output voltage to generate the high side reference ground potential; wherein the linear regulator circuit adjusts the high side reference ground potential to a predetermined reference ground target level according to the difference between the predetermined reference voltage and the high side reference ground potential; wherein the voltage drop of the first high voltage power rail is at least twice the voltage drop of the second low voltage power rail.

In one embodiment, the switch control circuit includes: a charging MOSFET driving circuit, configured to switch the gate of the charging MOSFET to the boosted voltage or the battery voltage in correspondence with turning ON or OFF the charging MOSFET according to the switch control signal; and a discharging MOSFET driving circuit, configured to switch the gate of the discharging MOSFET to the boosted voltage or the battery pack voltage in correspondence with turning ON or OFF the discharging MOSFET according to the switch control signal.

The advantage of the present invention is that the circuit design according to the present invention allows at least part of devices of the circuit's operating voltage range to be between the battery voltage and the high side reference ground potential. This design enables the construction of boost control circuits in high voltage battery control systems with lower withstand voltage devices, reducing circuit area and manufacturing costs. Unlike prior art high side charge pump control circuits without feedback control, risking device overvoltage or necessitating higher withstand voltage devices for design, increasing costs, this invention employs feedback control on the high side charge pump. This not only lowers system costs but also enhances system adaptability and reliability.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a voltage boost control circuit of a prior art high voltage battery control system.

FIG. 2 is a block diagram illustrating a high voltage battery control system and its high side boost control circuit according to an embodiment of the present invention.

FIG. 3 is a schematic diagram of the boost circuit according to an embodiment of the present invention.

FIGS. 4A and 4B are schematic diagrams of the feedback signal generation circuit according to an embodiment of the present invention.

FIG. 5 is a schematic diagram of the comparison circuit according to an embodiment of the present invention.

FIG. 6 is a block diagram of the linear regulation circuit according to an embodiment of the present invention.

FIG. 7 is a more detailed schematic diagram of the linear regulation circuit according to an embodiment of the present invention.

FIG. 8 is a schematic diagram of the switch control circuit according to an embodiment of the present invention.

FIG. 9 is a more detailed schematic diagram of the charging MOSFET control circuit within the switch control circuit according to an embodiment of the present invention.

FIG. 10 is a more detailed schematic diagram of the discharging MOSFET control circuit within the switch control circuit according to an embodiment of the present invention.

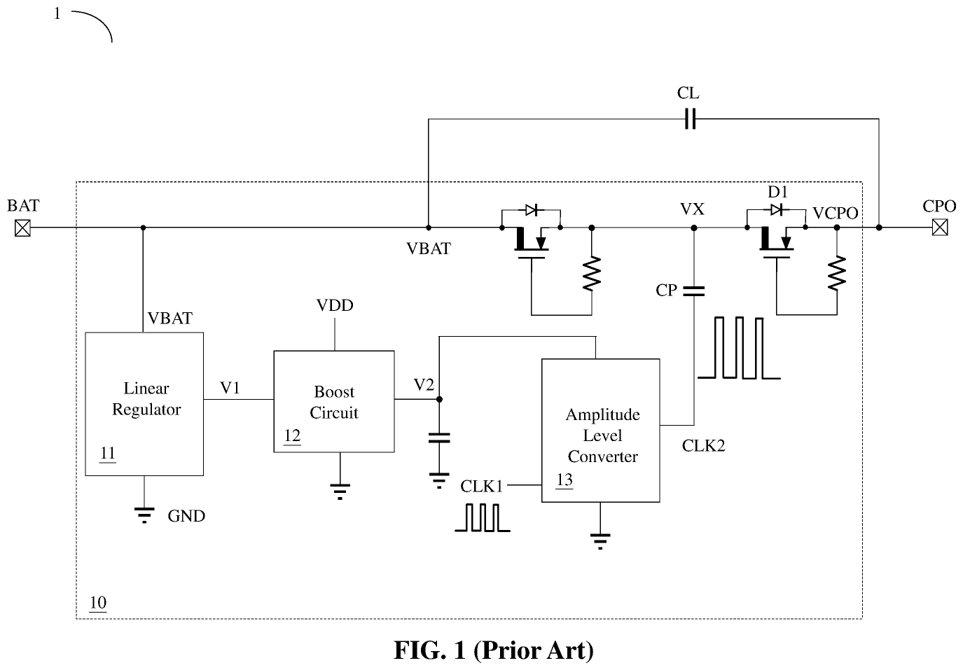

### DESCRIPTION OF THE PREFERRED EMBODIMENTS

The drawings as referred to throughout the description of the present invention are for illustration only, to show the interrelations between the circuits and the signal waveforms, but not drawn according to actual scale.

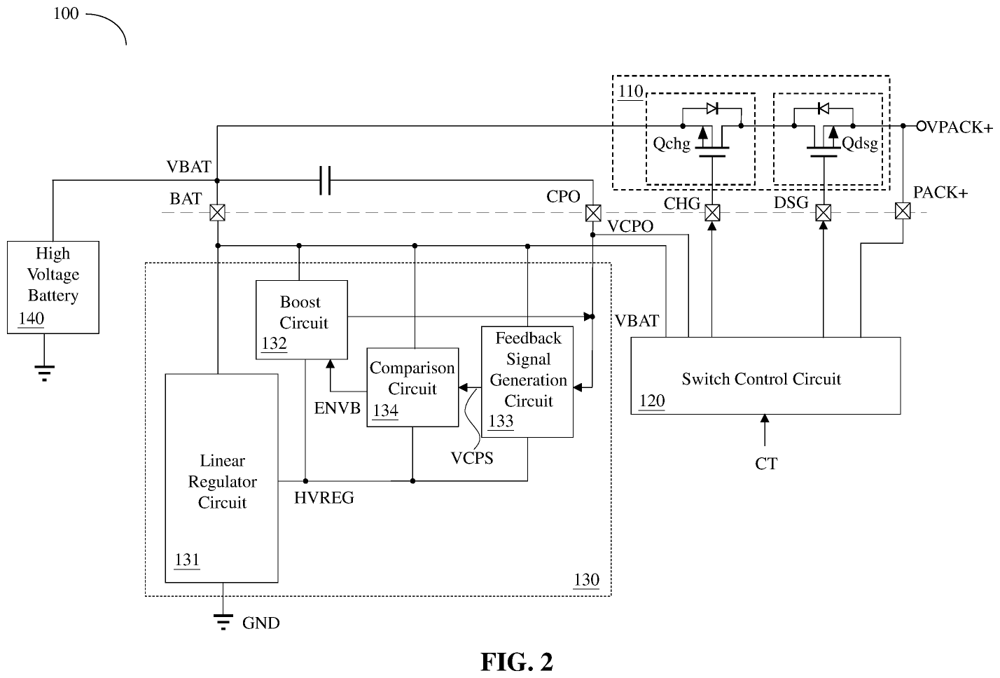

FIG. 2 illustrates a block diagram of a high voltage battery control system and its high side voltage boost control circuit according to an embodiment of the present invention. The high voltage battery control system 100 includes a metal oxide semiconductor field effect transistor (MOSFET) unit 110, a switch control circuit 120, and a boost control circuit 130. The MOSFET unit 110 includes a charging MOSFET Qchg and a discharging MOSFET Qdsg, wherein the charging MOSFET Qchg and the discharging MOSFET Qdsg in one embodiment are NMOS transistors connected in series with their body diodes reversely coupled to each other. The charging MOSFET Qchg and the discharging MOSFET Qdsg are connected between a battery voltage pin BAT having a battery voltage VBAT and a battery pack voltage pin PACK+ having a battery pack voltage VPACK+. The switch control circuit 120 controls the charging MOSFET Qchg and the discharging MOSFET Qdsg according to a switch control signal CT to control charging/discharging current, thereby determining whether to charge/discharge the high voltage battery 140. The boost control circuit 130 is configured to operably provide a boosted voltage VCPO to the switch control circuit 120 to control the charging MOSFET Ochg and the discharging MOSFET Qdsg, wherein the boosted voltage VCPO is higher than the battery voltage VBAT, and a voltage difference between the boosted voltage VCPO and the battery voltage VBAT is at least not lower than conductive threshold voltages of the charging MOSFET Qchg and the discharging MOSFET Qdsg.

The boost control circuit 130 includes a linear regulator circuit 131, a boost circuit 132, a feedback signal generation circuit 133, and a comparison circuit 134. The linear regulator circuit 131 is powered by a first high voltage power rail formed by the battery voltage VBAT and the ground potential GND, which generates a high side reference ground potential HVREG. It allows the boost circuit 132, the feedback signal generation circuit 133, and the comparison circuit 134 to operate in a first low voltage power rail with a low drop, e.g., less than 10V, thus enabling the use of devices with lower a withstand voltage, reducing manufacturing costs.

The boost circuit 132 is powered by a first low voltage power rail formed by the battery voltage VBAT and the high side reference ground potential HVREG. The boost circuit 132 is configured to operably convert the first low voltage power rail to a second high voltage power rail formed by the boosted voltage VCPO and the high side reference ground potential HVREG according to the boost enable signal ENVB, and regulates the boosted voltage VCPO to a predetermined target voltage.

The feedback signal generation circuit 133 is powered by the first low voltage power rail, and is configured to operably generate a feedback voltage VCPS according to the boosted voltage VCPO, wherein the feedback voltage VCPS is positively correlated to the boosted voltage VCPO. The feedback voltage VCPS may be a divided voltage of the boosted voltage VCPO or a voltage generated by shifting a level of the boosted voltage VCPO.

The comparison circuit 134 is powered by the first low voltage power rail, and is configured to operably compare the feedback voltage VCPS with a reference voltage to generate the boost enable signal ENVB. The battery voltage VBAT is higher than the withstand voltage of at least one device in the boost circuit 132, the feedback signal generation circuit 133, and the comparison circuit 134. As these circuits operate on a first low voltage power rail with a voltage drop lower than 10V, it is possible to use devices with lower withstand voltages, thus reducing manufacturing costs. A voltage drop of the first high voltage power rail is greater than a voltage drop of the first low voltage power rail, and a voltage drop of the second high voltage power rail is also greater than the voltage drop of the first low voltage power rail. The boosted voltage VCPO (relative to the ground potential GND) is higher than the battery voltage VBAT (relative to the ground potential GND).

It is noted that, according to the present invention, when mentioning that one voltage is higher or lower than another voltage, it refers to a comparison of the two voltages each relative to the ground potential GND. In one embodiment, for instance, as shown in FIG. 2, the gate and source of the charge MOSFET Qchg are respectively connected to a charge gate pin CHG and the battery pin BAT. The switch control circuit 120 receives both the boosted voltage VCPO and the battery voltage VBAT, with the voltage difference between VCPO and VBAT being higher than the conductive threshold voltage of the charge MOSFET Qchg. The switch control circuit 120 can determine to connect either the boosted voltage VCPO or the battery voltage VBAT to the charge gate pin CHG to turn ON or OFF the charge MOSFET Qchg of the MOSFET unit 110. Thus, the boosted voltage VCPO is higher than the battery voltage VBAT. On the other hand, the boost circuit 132, the feedback signal generation circuit 133, and the comparison circuit 134 operate on the first low voltage power rail with a low voltage drop, allowing the use of devices with lower withstand voltages, which further reduces manufacturing costs and circuit size. In summary, relative to the ground potential, the boosted voltage VCPO is higher than the battery voltage VBAT, the battery voltage VBAT is higher than the high side reference ground potential HVREG, and the high side reference ground potential HVREG is higher than the ground potential GND. Additionally, in one embodiment, the voltage drop of the first high voltage power rail is higher than that of the second high voltage power rail, and both are higher than the voltage drop of the first low voltage power rail. Also, relative to the ground potential, the battery voltage VBAT is higher than the withstand voltage of at least one device in the boost circuit 132, the feedback signal generation circuit 133, and the comparison circuit 134.

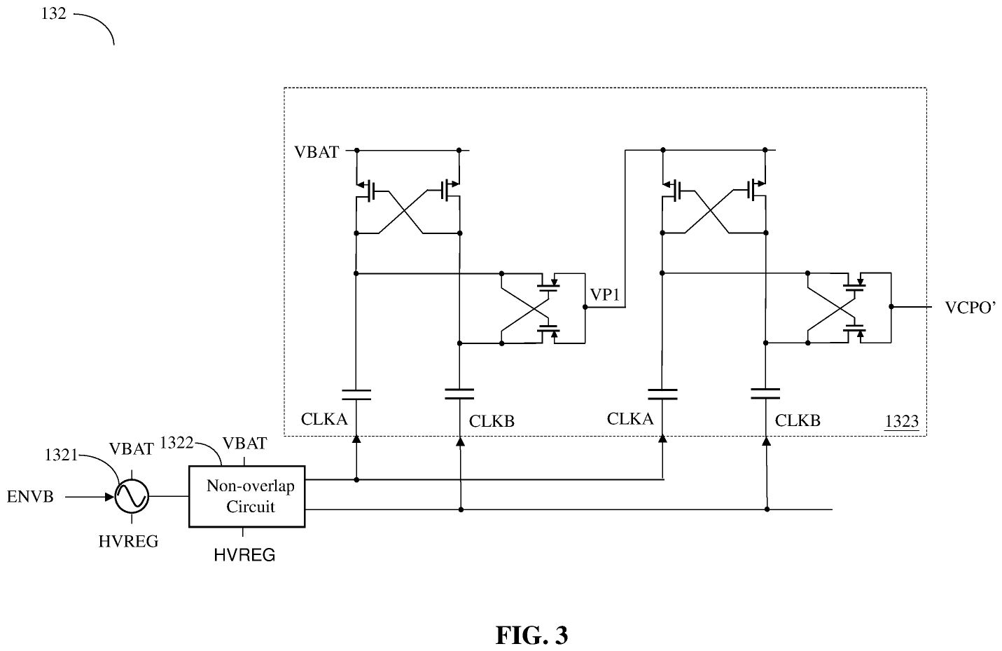

FIG. 3 illustrates a schematic diagram of the boost circuit according to an embodiment of the present invention. As shown in FIG. 3, the boost circuit 132 may include, but is not limited to, a voltage multiplier circuit 1323. When enabled by the boost enable signal ENVB and in an open-loop state, the boost circuit 132 converts the first low voltage power rail into an N-times voltage power rail through an N-fold conversion, wherein a voltage drop of the N-times voltage power rail is N times the voltage drop of the first low voltage power rail, with N being a real number greater than 1.

For instance, as shown in FIG. 3, the boost circuit 132 includes an oscillator 1321, a non-overlap circuit 1322, and a voltage multiplier circuit 1323. The oscillator 1321, the non-overlap circuit 1322, and the voltage multiplier circuit 1323 are all powered by the first low voltage power rail formed by the battery voltage VBAT (for example, 60V) and the high side reference ground potential HVREG (for example, 55V), with a voltage drop (for example, 5V). Once enabled by the boost enable signal ENVB, the oscillator 1321 generates an oscillating clock signal between the battery voltage VBAT and the high side reference ground potential HVREG, which is input to the non-overlap circuit 1322. The non-overlap circuit 1322 receives the clock signal and generates non-overlapping and inversely phased clock signals CLKA and CLKB, both having an amplitude equal to the voltage difference between the battery voltage VBAT and the high side reference ground potential HVREG (for example, 5V).

Continuing with FIG. 3, the voltage multiplier circuit 1323 includes for example but not limited to two single-stage charge pumps connected in series, to generate an open-loop boosted voltage VCPO′ under an open-loop condition. In this embodiment, the level of the open-loop boosted voltage VCPO′ is a sum of the battery voltage VBAT and twice a voltage difference between the battery voltage VBAT and the high side reference ground potential HVREG, i.e., open-loop boosted voltage VCPO′=VBAT+2*(VBAT−HVREG), which is also equivalent to the high side reference ground potential HVREG plus three times the voltage difference between the battery voltage VBAT and the high side reference ground potential HVREG of the first low voltage power rail.

As shown in FIG. 3, at the open-loop state, an output of a first single-stage charge pump generates a boosted voltage VP1 as a sum of the battery voltage VBAT and the voltage difference between the battery voltage VBAT and the high side reference ground potential HVREG, i.e., VP1=VBAT+(VBAT−HVREG); the output of a second single-stage charge pump generates the open-loop boosted voltage VCPO′ as the sum of the battery voltage VBAT and twice the voltage difference between the battery voltage VBAT and the high side reference ground potential HVREG, i.e., the open-loop boosted voltage VCPO′=VBAT+2*(VBAT−HVREG). This embodiment is only one of possible implementations according to the present invention and is not intended to limit the scope of the present invention. The number of serially connected single-stage charge pumps can be increased as needed to elevate the open-loop boosted voltage VCPO′.

For example, if the battery voltage VBAT is 60V and the high side reference ground potential HVREG is 55V, with a voltage drop across the first low voltage power rail being 5V, the voltage multiplier circuit 1323 may include three serially connected single-stage charge pumps, making the open-loop boosted voltage VCPO′ equal to the battery voltage VBAT (for example, 60V) plus three times the voltage difference between the battery voltage VBAT (for example, 60V) and the high side reference ground potential HVREG (for example, 55V) of 5V, resulting in an open-loop boosted voltage VCPO′=VBAT+3*(VBAT−HVREG), with the open-loop boosted voltage VCPO′ being approximately 75V.

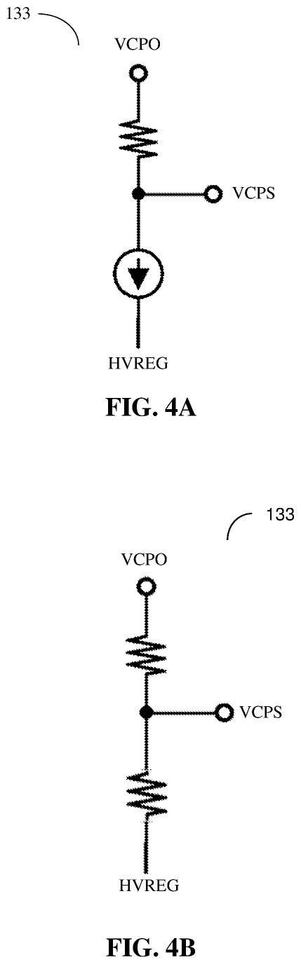

FIGS. 4A and 4B show schematic diagrams of the feedback signal generation circuit according to an embodiment of the present invention. As illustrated in FIG. 4A, the feedback signal generation circuit 133 includes for example but not limited to a level shifter circuit coupled between the boosted voltage VCPO and the high side reference ground potential HVREG. The level shifter circuit shifts a level of the boosted voltage VCPO by a first predetermined level to generate the feedback voltage VCPS. In FIG. 4A, the feedback voltage VCPS is the voltage drop generated by the current supplied by a current source through a resistor subtracted from the boosted voltage VCPO.

As shown in FIG. 4B, the feedback signal generation circuit 133 includes for example but not limited to a voltage divider circuit coupled between the boosted voltage VCPO and the high side reference ground potential HVREG. The feedback voltage VCPS is a divided voltage of the voltage difference between the boosted voltage VCPO and the reference ground potential HVREG across the lower resistor of two series resistors.

It should be noted that in a preferred embodiment, the level of the feedback voltage VCPS lies between the boosted voltage VCPO and the high side reference ground potential HVREG.

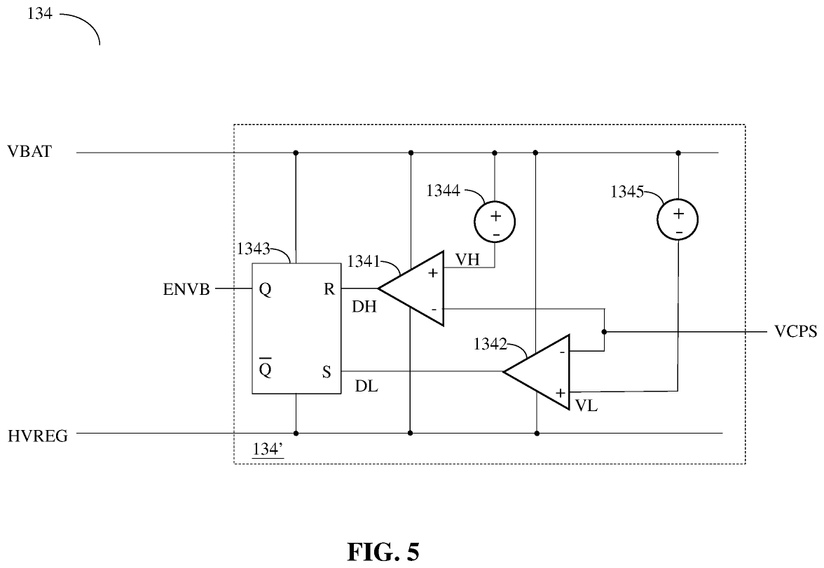

FIG. 5 presents a schematic diagram of the comparison circuit according to an embodiment of the present invention. As shown in FIG. 5, the comparison circuit 134 includes a hysteresis comparison circuit 134′ with a hysteresis function. The hysteresis comparison circuit 134′ compares the feedback voltage VCPS with an upper reference voltage VH and a lower reference voltage VL. When the feedback voltage VCPS exceeds the upper reference voltage VH or falls below the lower reference voltage VL, the hysteresis comparison circuit 134′ dynamically adjusts a state of the boost enable signal ENVB through a hysteresis control mechanism, thereby enabling or disabling the boost circuit 132. This feedback control regulates the boosted voltage VCPO between an upper predetermined target voltage and a lower predetermined target voltage, wherein the upper and lower predetermined target voltages correspond respectively to the upper reference voltage VH and the lower reference voltage VL. The predetermined target voltages include the upper predetermined target voltage and the lower predetermined target voltage. The reference voltages include the upper reference voltage VH and the lower reference voltage VL.

More specifically, as shown in FIG. 5, the hysteresis comparison circuit 134′ includes an upper limit comparator 1341, a lower limit comparator 1342, a logic circuit 1343, an upper limit bias circuit 1344, and a lower limit bias circuit 1345. The upper limit comparator 1341 compares the feedback voltage VCPS with the upper reference voltage VH to generate an upper comparison result DH. The lower limit comparator 1342 compares the feedback voltage VCPS with the lower reference voltage VL to generate a lower comparison result DL. The logic circuit 1343, exemplified by an RS flip-flop as shown in FIG. 5, dynamically adjusts the state of the boost enable signal ENVB according to the upper and lower comparison results DH and DL, utilizing a hysteresis control mechanism. The upper limit bias circuit 1344 provides the upper reference voltage VH within the first low voltage power rail to the upper limit comparator 1341. The lower limit bias circuit 1345 provides the lower reference voltage VL within the first low voltage power rail to the lower limit comparator 1342. In one embodiment, the upper predetermined target voltage is a sum of the upper reference voltage VH and the offset voltage of the upper limit bias circuit 1344, and the lower predetermined target voltage is a sum of the lower reference voltage VL and the offset voltage of the lower limit bias circuit 1345.

For example, relative to the ground potential GND, suppose the battery voltage VBAT is 60V, and the high side reference ground potential HVREG is 55V. In an open-loop state, the boost circuit 132, including a series of three single-stage charge pumps, can provide an open-loop boosted voltage VCPO′ of 75V. In one embodiment, the feedback signal generation circuit 133 may shift the level of the boosted voltage VCPO by a first predetermined level (e.g., −15V), relative to GND, reducing the level of the boosted voltage VCPO by 15V to generate the feedback voltage VCPS, where the upper reference voltage VH might be 58V, and the lower reference voltage VL might be 57V. Thus, the boosted voltage VCPO could be regulated between 72V and 73V through a hysteresis control mechanism. It is important to note that the feedback voltage VCPS needs to be adjusted between the battery voltage VBAT and the high side reference ground potential HVREG.

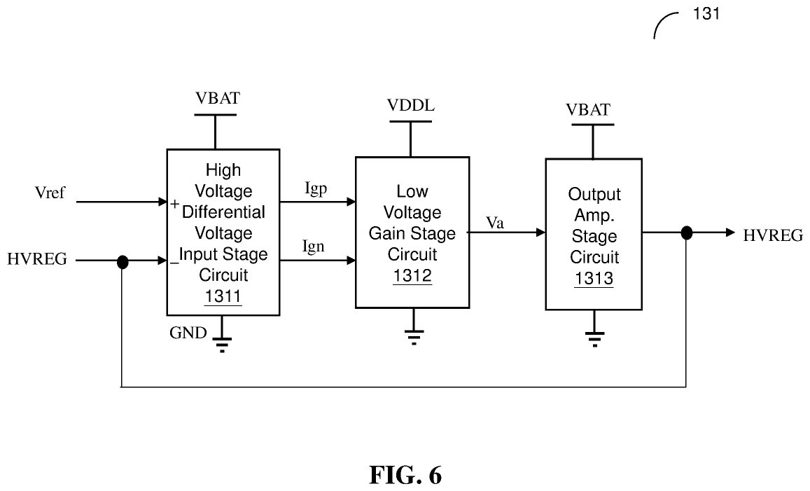

FIG. 6 shows a schematic diagram of the linear regulator circuit according to an embodiment of the present invention. As shown in FIG. 6, the linear regulator circuit 131 comprises: a high voltage differential voltage input stage circuit 1311, a low voltage gain stage circuit 1312, and an output amplification stage circuit 1313. The high voltage differential voltage input stage circuit 1311 is powered by the first high voltage power rail and generates a differential current pair, Igp and Ign, according to the difference between a predetermined reference voltage Vref and the high side reference ground potential HVREG. The low voltage gain stage circuit 1312 is powered by a second low voltage power rail formed between a low voltage power line VDDL and ground potential GND, has a transresistance, and converts the differential current pair into a transresistance output voltage Va. The output amplification stage circuit 1313 is powered by the first high voltage power rail and amplifies the transresistance output voltage Va to generate the high side reference ground potential HVREG. The linear regulator circuit 131 adjusts the high side reference ground potential HVREG to a predetermined reference ground target level according to the difference between the predetermined reference voltage Vref and the high side reference ground potential HVREG, where the voltage drop of the first high voltage power rail is at least twice the voltage drop of the second low voltage power rail.

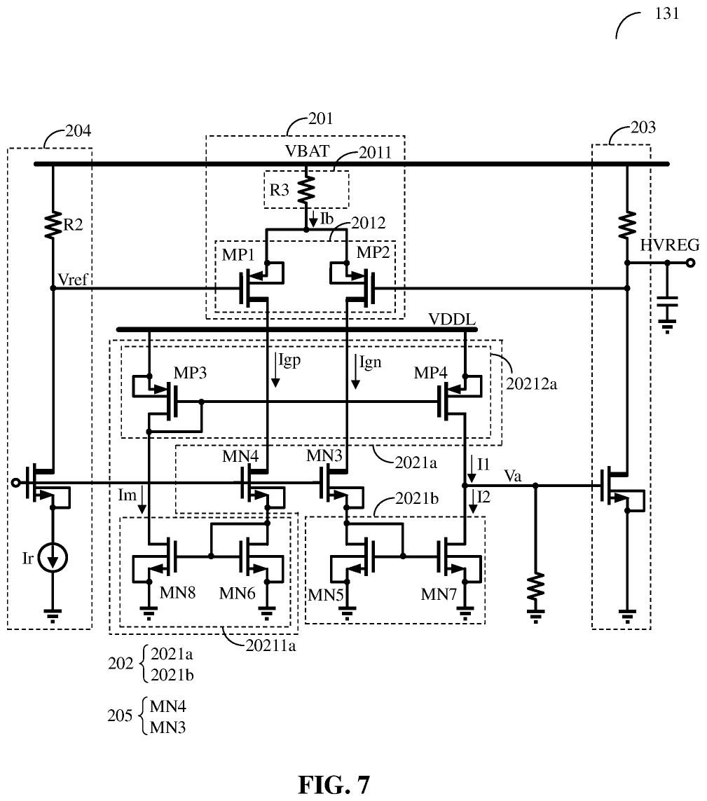

FIG. 7 illustrates a more specific diagram of the linear regulator circuit according to an embodiment of the present invention. As shown in FIG. 7, the linear regulator circuit 131 includes a high voltage differential voltage input stage circuit 201, a low voltage gain stage circuit 202, and an output amplification stage circuit 203.

As shown in FIG. 7, in this embodiment, the linear regulator circuit 131 additionally comprises a reference voltage generation circuit 204, which is powered by the high voltage power rail formed between the battery voltage VBAT and ground potential GND, to generate the reference voltage Vref.

In one embodiment, the high voltage side differential voltage input stage circuit 201 includes a bias circuit 2011 and a differential pair circuit 2012. The bias circuit 2011 is configured to receive the battery voltage VBAT and provide a bias current Ib. In this embodiment, the bias circuit 2011 includes a bias resistor R3, coupled between the battery voltage VBAT and the differential pair transistors 2012. The differential pair circuit 2012 comprises a pair of coupled differential MP2, transistors MP1 and configured to differentially distribute the bias current Ib according to the difference between the reference voltage Vref and the feedback voltage Vfb to generate a differential current pair Igp and Ign, where the withstand voltage of the differential pair transistors MP1 and MP2 is higher than the battery voltage VBAT.

The low voltage side gain stage circuit 202 in this embodiment includes a first current mirror circuit 2021a and a second current mirror circuit 2021b. The first current mirror circuit 2021a mirrors the positive end current Igp of the differential current pair Ign, Igp to generate a first current I1. The second current mirror circuit 2021b mirrors the negative end current Ign of the differential current pair Igp, Ign to generate a second current I2.

The first and second current mirror circuits 2021a and 2021b are coupled to each other, thus according to the first current I1 and the second current I2, a push-pull method is used to generate a transresistance output voltage Va. In one embodiment, the first current mirror circuit 2021a may include current mirrors 20211a and 20212a. The current mirror 20211a mirrors the positive end current Igp to generate an intermediate current Im, and the current mirror 20212a mirrors the intermediate current Im to generate the first current I1. Transistors MP4 and MN7 serve as the output current sources for the first current mirror circuit 2021a and the second current mirror circuit 2021b, respectively. Together, transistors MP4 and MN7 form a push-pull amplifier, according to the first current I1 and the second current I2, to generate a transresistance output voltage Va in a push-pull manner.

In one embodiment, the output amplification stage circuit 203 is configured to amplify the transresistance output voltage Va to generate the high voltage side reference ground potential HVREG. In this embodiment, the output amplification stage circuit 203 includes a resistor and a transistor connected in series, coupled between the battery voltage VBAT and the ground potential GND. The transistor receives the transresistance output voltage Va to generate the high voltage side reference ground potential HVREG.

In one embodiment, the reference voltage generation circuit 204 includes a resistor R2 and a current source Ir in series, coupled between the battery voltage VBAT and the ground potential GND, to provide the reference voltage Vref.

The linear regulator circuit 131 for generating the high voltage side reference ground potential HVREG may further include a clamping circuit 205, coupled between the high voltage side differential voltage input stage circuit 201 and the low voltage side gain stage circuit 202. The clamping circuit is configured to clamp the voltage received by the low voltage side gain stage circuit 202 from the high voltage side differential voltage input stage circuit 201 so as not to exceed predetermined clamping voltage. In one embodiment, the predetermined clamping voltage is lower than the withstand voltage of devices in the low voltage side gain stage circuit 202, such as transistors MN5, MN6. As shown in FIG. 7, in one embodiment, the battery voltage VBAT is higher than the withstand voltage of at least one device in the low voltage side gain stage circuit 202.

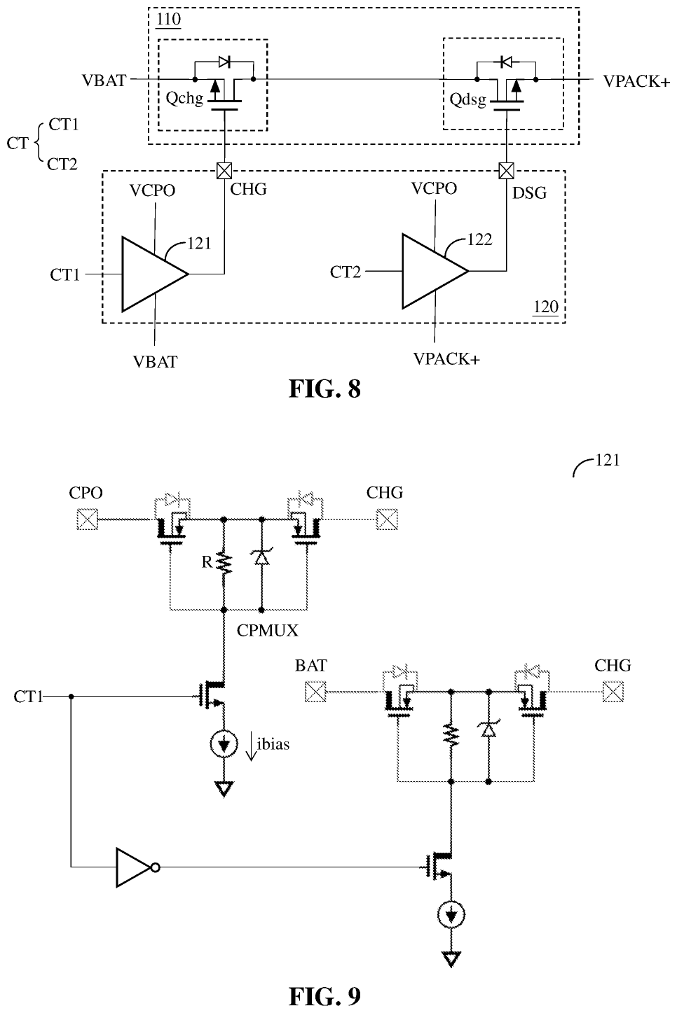

FIG. 8 shows a schematic diagram of a switch control circuit in accordance with an embodiment of the present invention. As shown in FIG. 8, the switch control circuit 120 includes a charging MOSFET drive circuit 121 and a discharging MOSFET drive circuit 122. The charging MOSFET drive circuit 121 is configured to switch the gate of the charging MOSFET Qchg to either the boosted voltage VCPO or the battery voltage VBAT according to a switch control signal CTI, thereby turning ON or OFF the charging MOSFET Qchg. The discharging MOSFET drive circuit 122 is configured to switch the gate of the discharging MOSFET Qdsg to either the boosted voltage VCPO or the battery pack voltage VPACK+ according to a switch control signal CT2, thereby turning ON or OFF the discharging MOSFET Qdsg. The switch control signal CT includes the switch control signals CT1 and CT2.

FIG. 9 shows a more specific diagram of the charging MOSFET control circuit of the switch control circuit in accordance with an embodiment of the present invention. As shown in FIG. 9, in this embodiment, the drive circuit 121 includes two high voltage PMOSFETs connected in series and coupled between the boost voltage pin CPO and the charging gate pin CHG, wherein the two high voltage PMOSFETs can withstand high voltages at the boost voltage pin CPO and the charging gate pin CHG. Additionally, a high voltage NMOSFET is connected to gates of these two high voltage PMOSFETs in the drive circuit 121 to withstand a high voltage at a node CPMUX, thus protecting a low voltage side current source. When the switch control signal CT1 turns ON the high voltage NMOSFET, gate-to-source voltages of the two high voltage PMOSFETs becomes equal to the bias current ibias times the resistance R, thereby turning ON the two high voltage PMOSFETs and electrically connecting the charging gate pin CHG to the boost voltage pin CPO with the boosted voltage VCPO, turning ON the charging MOSFET Qchg. A Zener diode is used to protect the gate-to-source voltage of the high voltage PMOSFETs from exceeding a protection voltage. Similarly, according to the switch control signal CT1, the charging gate pin CHG can be electrically connected to the battery voltage terminal BAT with the battery voltage VBAT, to turn OFF the charging MOSFET Qchg.

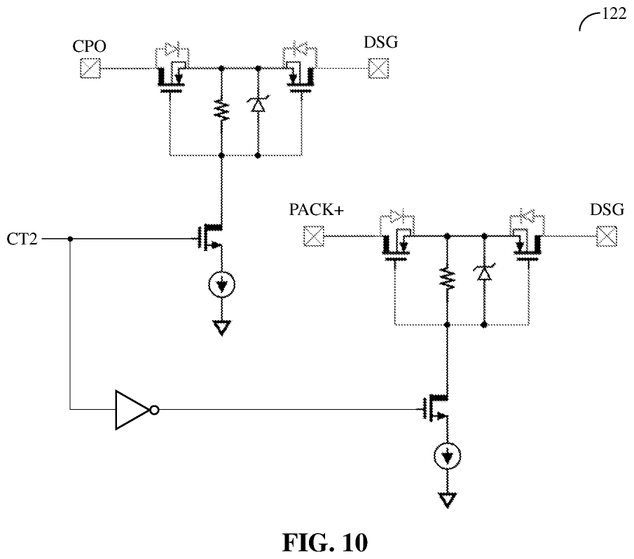

FIG. 10 shows a more specific schematic diagram of the discharging MOSFET control circuit of the switch control circuit in accordance with an embodiment of the present invention. The operation mechanism of the drive circuit 122 shown in FIG. 10 is similar to the embodiment shown in FIG. 9. According to the switch control signal CT2, a discharging gate pin DSG can be electrically connected to the boost voltage pin CPO with the boosted voltage VCPO, to turn ON the discharging MOSFET Qdsg; or the discharging gate pin DSG can be electrically connected to the battery pack voltage terminal PACK+ with the battery pack voltage VPACK+, to turn OFF the discharging MOSFET Qdsg.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. The various embodiments described above are not limited to being used alone; two embodiments may be used in combination, or a part of one embodiment may be used in another embodiment. For example, other process steps or structures, such as a metal silicide layer, may be added. For another example, the lithography process step is not limited to the mask technology but it can also include electron beam lithography, immersion lithography, etc. Therefore, in the same spirit of the present invention, those skilled in the art can think of various equivalent variations and various combinations, and there are many combinations thereof, and the description will not be repeated here. The scope of the present invention should include what are defined in the claims and the equivalents.

What is claimed is:

1. A high side voltage boost control circuit of a high voltage battery control system, comprising:
a linear regulator circuit, which is powered by a first high voltage power rail formed by a battery voltage and a ground potential, and is configured to operably generate a high side reference ground potential;
a boost circuit, which is powered by a first low voltage power rail formed by the battery voltage and the high side reference ground potential, and is configured to operably convert the first low voltage power rail into a second high voltage power rail formed by a boosted voltage and the high side reference ground potential, and regulate the boosted voltage to a predetermined target voltage according to a boost enable signal;
a feedback signal generation circuit, which is powered by the first low voltage power rail, and is configured to operably generate a feedback voltage according to the boosted voltage; and
a comparison circuit, which is powered by the first low voltage power rail, and is configured to operably compare the feedback voltage with a reference voltage to generate the boost enable signal;
wherein the battery voltage is higher than a withstand voltage of at least one device of the boost circuit, the feedback signal generation circuit, and the comparison circuit;
wherein a voltage drop of the first high voltage power rail is higher than a voltage drop of the first low voltage power rail;
wherein a voltage drop of the second high voltage power rail is higher than the voltage drop of the first low voltage power rail;
wherein the boosted voltage is higher than the battery voltage.

2. The high side voltage boost control circuit of claim 1, wherein the boost circuit includes a voltage multiplier circuit, and when the boost circuit is enabled and is in an open-loop state, converts the first low voltage power rail into an N-times voltage power rail by an N-fold conversion, wherein a voltage drop of the N-times voltage power rail is N times a voltage drop of the first low voltage power rail, and N is a real number greater than 1.

3. The high side voltage boost control circuit of claim 1, wherein the feedback signal generation circuit includes a level shifter circuit, which shifts a level of the boosted voltage by a first predetermined level to generate the feedback voltage.

4. The high side voltage boost control circuit of claim 1, wherein the feedback signal generation circuit includes a voltage divider circuit, which obtains a divided voltage of the boosted voltage to generate the feedback voltage.

5. The high side voltage boost control circuit of claim 1, wherein the predetermined target voltage includes an upper predetermined target voltage and a lower predetermined target voltage, and wherein the comparison circuit includes a hysteresis comparison circuit with a hysteresis function, which compares the feedback voltage with an upper reference voltage and a lower reference voltage, and when the feedback voltage exceeds the upper reference voltage or falls below the lower reference voltage, the hysteresis comparison circuit, through a hysteresis control mechanism, dynamically adjusts a state of the boost enable signal, thereby enabling or disabling the boost circuit to regulate the boosted voltage between the upper predetermined target voltage and the lower predetermined target voltage, wherein the upper predetermined target voltage and the lower predetermined target voltage correspond to one and the other of the upper reference voltage and the lower reference voltage, respectively.

6. The high side voltage boost control circuit of claim 5, wherein the hysteresis comparison circuit includes:
an upper limit comparator, which compares the feedback voltage with the upper reference voltage to generate an upper comparison result;
a lower limit comparator, which compares the feedback voltage with the lower reference voltage to generate a lower comparison result; and
a logic circuit, which dynamically adjusts the state of the boost enable signal through a hysteresis control mechanism according to the upper comparison result and the lower comparison result.

7. The high side voltage boost control circuit of claim 6, wherein the hysteresis comparison circuit further includes:
an upper limit bias circuit, which provides the upper reference voltage to the upper limit comparator within the first low voltage power rail; and
a lower limit bias circuit, which provides the lower reference voltage to the lower limit comparator within the first low voltage power rail.

8. The high side voltage boost control circuit of claim 1, wherein the linear regulator circuit includes:
a high side differential voltage input stage circuit, which is powered by the first high voltage power rail, and is configured to generate a differential current pair according to a difference between a predetermined reference voltage and the high side reference ground potential;
a low side gain stage circuit, which is powered by a second low voltage power rail, has a transresistance, and is configured to convert the differential current pair to generate a transresistance output voltage; and
an output amplification stage circuit, which is powered by the first high voltage power rail, and is configured to operably amplify the transresistance output voltage to generate the high side reference ground potential;
wherein the linear regulator circuit adjusts the high side reference ground potential to a predetermined reference ground target level according to the difference between the predetermined reference voltage and the high side reference ground potential;
wherein the voltage drop of the first high voltage power rail is at least twice the voltage drop of the second low voltage power rail.

9. A high voltage battery control system, comprising:
a high side voltage boost control circuit, which includes:
a linear regulator circuit, which is powered by a first high voltage power rail formed by a battery voltage and a ground potential, and is configured to operably generate a high side reference ground potential;
a boost circuit, which is powered by a first low voltage power rail formed by the battery voltage and the high side reference ground potential, and is configured to operably convert the first low voltage power rail into a second high voltage power rail formed by a boosted voltage and the high side reference ground potential, and regulate the boosted voltage to a predetermined target voltage according to a boost enable signal;
a feedback signal generation circuit, which is powered by the first low voltage power rail, and is configured to operably generate a feedback voltage according to the boosted voltage; and
a comparison circuit, which is powered by the first low voltage power rail, and is configured to operably compare the feedback voltage with a reference voltage to generate the boost enable signal;
wherein the battery voltage is higher than a withstand voltage of at least one device of the boost circuit, the feedback signal generation circuit, and the comparison circuit;
wherein a voltage drop of the first high voltage power rail is higher than a voltage drop of the first low voltage power rail;
wherein a voltage drop of the second high voltage power rail is higher than the voltage drop of the first low voltage power rail;
wherein the boosted voltage is higher than the battery voltage;
a metal oxide semiconductor field effect transistor (MOSFET) unit, including a charging MOSFET and a discharging MOSFET connected in series between the battery voltage and a battery pack voltage; and
a switch control circuit, powered by the second high voltage power rail, configured to control the charging and discharging MOSFETS according to a switch control signal, thereby controlling a charging/discharging current to decide charging/discharging of a high voltage battery.

10. The high voltage battery control system of claim 9, wherein the boost circuit includes a voltage multiplier circuit, and when the boost circuit is enabled and is in an open-loop state, converts the first low voltage power rail into an N-times voltage power rail by an N-fold conversion, wherein a voltage drop of the N-times voltage power rail is N times a voltage drop of the first low voltage power rail, and N is a real number greater than 1.

11. The high voltage battery control system of claim 9, wherein the feedback signal generation circuit includes a level shifter circuit, which shifts a level of the boosted voltage by a first predetermined level to generate the feedback voltage.

12. The high voltage battery control system of claim 9, wherein the feedback signal generation circuit includes a voltage divider circuit, which obtains a divided voltage of the boosted voltage to generate the feedback voltage.

13. The high voltage battery control system of claim 9, wherein the predetermined target voltage includes an upper predetermined target voltage and a lower predetermined target voltage, and wherein the comparison circuit includes a hysteresis comparison circuit with a hysteresis function, which compares the feedback voltage with an upper reference voltage and a lower reference voltage, and when the feedback voltage exceeds the upper reference voltage or falls below the lower reference voltage, the hysteresis comparison circuit, through a hysteresis control mechanism, dynamically adjusts a state of the boost enable signal, thereby enabling or disabling the boost circuit to regulate the boosted voltage between the upper predetermined target voltage and the lower predetermined target voltage, where the upper predetermined target voltage and the lower predetermined target voltage correspond to one and the other of the upper reference voltage and the lower reference voltage, respectively.

14. The high voltage battery control system of claim 13, wherein the hysteresis comparison circuit includes:
an upper limit comparator, which compares the feedback voltage with the upper reference voltage to generate an upper comparison result;
a lower limit comparator, which compares the feedback voltage with the lower reference voltage to generate a lower comparison result; and
a logic circuit, which dynamically adjusts the state of the boost enable signal through a hysteresis control mechanism according to the upper comparison result and the lower comparison result.

15. The high voltage battery control system of claim 14, wherein the hysteresis comparison circuit further includes:
an upper limit bias circuit, which provides the upper reference voltage to the upper limit comparator within the first low voltage power rail; and
a lower limit bias circuit, which provides the lower reference voltage to the lower limit comparator within the first low voltage power rail.

16. The high voltage battery control system of claim 9, wherein the linear regulator circuit includes:
a high side differential voltage input stage circuit, which is powered by the first high voltage power rail, and is configured to generate a differential current pair according to a difference between a predetermined reference voltage and the high side reference ground potential;
a low side gain stage circuit, which is powered by a second low voltage power rail, has a transresistance, and is configured to convert the differential current pair to generate a transresistance output voltage; and
an output amplification stage circuit, which is powered by the first high voltage power rail, and is configured to operably amplify the transresistance output voltage to generate the high side reference ground potential;
wherein the linear regulator circuit adjusts the high side reference ground potential to a predetermined reference ground target level according to the difference between the predetermined reference voltage and the high side reference ground potential;
wherein the voltage drop of the first high voltage power rail is at least twice the voltage drop of the second low voltage power rail.

17. The high voltage battery control system of claim 9, wherein the switch control circuit includes:
a charging MOSFET driving circuit, configured to switch the gate of the charging MOSFET to the boosted voltage or the battery voltage in correspondence with turning ON or OFF the charging MOSFET according to the switch control signal; and
a discharging MOSFET driving circuit, configured to switch the gate of the discharging MOSFET to the boosted voltage or the battery pack voltage in correspondence with turning ON or OFF the discharging MOSFET according to the switch control signal.
